(19) United States
(12) Patent Application Publication
(10) Pub. No.: US 2024/0383209 A1
(43) Pub. Date: Nov. 21, 2024

(54) SYSTEMS AND METHODS FOR 3D PRINTING AND A MULTIMATERIAL 3D PRINTER

(71) Applicant: SpaceFab.US, Inc., Laguna Niguel, CA (US)

(72) Inventors: Randall M. CHUNG, Laguna Niguel, CA (US); Sean LEAGUE, Laguna Niguel, CA (US)

(73) Assignee: SpaceFab.US, Inc., Laguna Niguel, CA (US)

(21) Appl. No.: 18/694,085

(22) PCT Filed: Sep. 23, 2022
(86) PCT No.: PCT/US2022/044525

§ 371 Date: Mar. 21, 2024

Related U.S. Application Data
(60) Provisional application No. 63/247,422, filed on Sep. 23, 2021.

(51) Int. Cl. B29C 64/393; B29C 64/118; B29C 64/268; B29C 64/371; B33Y 10/00; B33Y 30/00; B33Y 50/02; B33Y 70/10

(52) U.S. Cl. CPC B29C 64/393; B29C 64/118; B29C 64/268; B29C 64/371; B33Y 10/00; B33Y 30/00; B33Y 50/02; B33Y 70/10

(57) ABSTRACT

Configurations are provided to print a complex parts with a mix of materials. Configurations are provided to print multiple dissimilar materials, such as powdered metal mixed with a binder material, powdered ceramic mixed with a binder material, and plastic, into the same object. A focused beam of light may be used to heat each layer to remove any binder material and to fuse the metal powder particles or ceramic powder particles together. Embodiments include practical enhancements to 3D printing including emitting an inert gas over the heated area to prevent metal powder particles from reacting or oxidizing in room air, removing and filtering noxious fumes when optically heating the deposited filament, using a camera and laser light beam to monitor heating, adjusting focus of light beams, and adjusting the power of a light beam depending on the material, size of the light beam, and speed of the light beam movement.

### CROSS REFERENCE TO RELATED APPLICATION

This application is the National Stage entry under 35 U.S.C. § 371 of International Application No. PCT/US22/44525, filed Sep. 23, 2023, which claims priority to U.S. provisional application No. 63/247,422 titled MULTIMATERIAL 3D PRINTER filed on Sep. 23, 2021, the content of which is expressly incorporated by reference in its entirety.

### FIELD

The present disclosure generally relates to systems and processes for additive manufacturing, and more particularly to three-dimensional (3D) printers and printing processes for multiple materials.

### BACKGROUND

Existing 3D printers can use filaments of materials which are melted, extruded, and deposited as described, for example, in U.S. Pat. No. 5,121,329. In conventional systems, plastic filaments are usually composed entirely of plastic material, such as a thermoplastic. Thermoplastics can be heated and melted more than once. Other plastics, such as thermoset plastics can be melted only once, and are generally not used in 3D filament type printers. Some plastic filaments may be mostly plastic with an amount of reinforcing material such as glass fiber, Kevlar fiber, or carbon fiber.

For filaments composed mostly of metal or ceramic material, the filament is made of metal or ceramic powder mixed with a small amount of binder material such as thermoplastic, wax or other meltable material. The purpose of the binder material is to allow the metal or ceramic powder to be formed into a cylindrical filament form, to allow the filament mixture to be strong enough to moved off of a spool and into the extruder mechanism, and to allow the metal/binder filament mixture to soften enough to be extruded out of a nozzle and deposited into a thin layer pattern.

There are other types of printers, such as the metal powder bed 3D printer as described, for example, in U.S. Pat. No. 5,204,055, which uses a laser or other energy beam to sinter or melt a pattern onto the top layer of a bed of metal powder. It is also possible to replace the metal powder in a powder bed 3D printer or binder jetting printer with plastic powder.

There is also a 3D printer type that uses the binder jetting process, as described, for example, in U.S. Pat. No. 5,340,656, where a binding liquid is jetted or sprayed onto a bed of metal powder to bind with the powder. For these types of metal printers, the metal powder can be a health hazard if inhaled, or an explosive hazard if blown into the air. The printing chamber must be kept sealed to prevent the escape of metal dust, and workers may need to wear protective clothing and respirators.

There exists a need for improved manufacturing processes and systems for additive manufacturing. There also exists a need to address one or more drawbacks of existing systems and processes.

### BRIEF SUMMARY OF THE EMBODIMENTS

The disclosure is directed to systems and processes for 3D printing and multimaterial 3D printing. In one embodiment, a method for 3D printing includes setting, by a device, a first tool head, and extruding, by the device, at least one layer of melted filament from the first tool head relative to at least one of a print bed and a layer to deposit material. The method also includes controlling, by the device, at least one optical heating head to generate a laser light beam to heat deposited material, wherein the optical heating head is controlled to heat deposited material to debind the deposited material and wherein the optical heating head is controlled to sinter debinded material. The method also includes controlling, by the device, emission of an inert gas over the heated area in association with heating of deposited material, and monitoring, by the device, heating of the deposited material using camera image data and the laser light beam, wherein control of the optical heating head includes using the camera image data to adjust focus and power of the laser light beam.

In one embodiment, the optical heating head is configured to output a focused laser light beam, and wherein control of the laser light beam includes control of laser light beam focus, laser light beam size, and laser light beam speed of movement.

In one embodiment, debinding includes control of the laser light beam to heat each layer of deposited material before depositing an additional layer.

In one embodiment, monitoring heating of the deposited material using camera image data includes inspecting deposited material for defects.

In one embodiment, emission of an inert gas is controlled to prevent metal powder particles from at least one of reacting and oxidizing in air in a printing chamber.

In one embodiment, the method also includes at least one of diluting, redirecting and filtering air in a printing chamber to remove fumes when optically heating deposited filament.

In one embodiment, the method also includes milling deposited material prior to heating deposited material.

In one embodiment, the method also includes controlling, by the device, a tool head change to a second tool head, extruding, by the device, at least one layer of melted filament from the second tool head relative to at least one of the print bed and deposited material, wherein the first tool head and the second tool head are configured to print different materials to form at least a portion of an integrated part.

In one embodiment, the method also includes adjusting at least one of focus, size and power of a laser light beam of the optical head.

Another embodiment is directed to a device configured for 3D printing. The device includes a first tool head configured to deposit a material, an optical head configured to heat deposited material and a controller. The controller is configured to set the first tool head and control extruding of extruding of at least one layer of melted filament from the first tool head relative to at least one of a print bed and a layer to deposit material. The controller is also configured to control at least one optical heating head to generate a laser light beam to heat deposited material, wherein the optical heating head is controlled to heat deposited material to debind the deposited material and wherein the optical heating head is controlled to sinter debinded material. The controller is also configured to control emission of an inert gas over the heated area in association with heating of deposited material, and monitor heating of the deposited material using camera image data and the laser light beam, wherein control of the optical heating head includes using the camera image data to adjust focus and power of the laser light beam.

Another embodiment is directed to a method for multimaterial 3D printing. The method includes setting, by a device, a first tool head, and extruding, by the device, at least one layer of melted filament from the first tool head relative to at least one of a print bed and a layer to deposit material. The method also includes controlling, by the device, a tool head change to a second tool head, and extruding, by the device, at least one layer of melted filament from the second tool head relative to at least one of the print bed and deposited material. The method also includes controlling, by the device, a tool head change to a third tool head, and milling, by the device, at least a portion of the deposited material. The method also includes controlling, by the device, a tool head change to a fourth tool head. The method also includes controlling, by the device, at least one optical heating head to generate a laser light beam to heat deposited material, wherein the optical heating head is controlled to heat deposited material to debind the deposited material and wherein the optical heating head is controlled to sinter debinded material.

In one embodiment, the method also includes monitoring heating of the deposited material using camera image data and the laser light beam, wherein control of the optical heating head includes using the camera image data to adjust focus and power of the laser light beam

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is the top view of a 3D printer configuration according to one or more embodiments;

FIG. 2 is a front view of a 3D printer configuration according to one or more embodiments;

FIG. 3 is a front view of a 3D printer according to one or more embodiments;

FIG. 4A is a graphical representation of an optical heating head according to one or more embodiments;

FIG. 4B is a graphical representation of an optical heating head according to one or more other embodiments;

FIG. 5A illustrates a process for 3D printing according to one or more embodiments;

FIG. 5B illustrates a process for 3D printing according to one or more other embodiments; and

FIG. 6 is a device configuration according to one or more embodiments.

### DETAILED DESCRIPTION OF THE EXEMPLARY EMBODIMENTS

### Overview and Terminology

One aspect of the disclosure is directed to configurations and processes for 3D printing of complex parts that can include a mix of materials, including dissimilar materials, such as powdered metal mixed with a binder material, powdered ceramic mixed with a binder material, and plastic, into the same object. Processes and system components are provided for depositing multiple layers and processing layers including one or more of debinding and sintering. Another aspect of the disclosure is directed to system configurations and processes for 3D printing including optical heating during manufacturing of one or more layers. According to one embodiment, a focused beam of light is used to heat each layer to remove any binder material and to fuse dissimilar materials together, such as the metal powder particles and ceramic powder particles. The disclosure includes practical enhancements to 3D printer configurations and processes. By way of example, embodiments include providing a system configuration for a 3D printing device including a plurality of tool heads and structural elements to remove and return tool heads to one or more tool holders. In addition, the device may include a controller for controlling operation of one or more of a tool head and tool head carriage. The system may provide one or more advances over existing manufacturing methods including components and control for emitting an inert gas over the heated area to prevent metal powder particles from reacting or oxidizing in room air. Another advance may be components and control for one or more of removing and filtering noxious fumes when optically heating the deposited filament. Components and control are also provided for imaging using a camera and laser light beam to monitor of deposited material. Embodiments are also provided for control of an optical tool head including adjust the focus of the light beam, adjusting the power (e.g., average power and peak power) of the light beam depending on the material, the size of the light beam, and the speed of the light beam's movement.

According to embodiments, systems and methods are provided for multimaterial 3D printing including operations to mill deposited material before one or more stages of heating and/or prior to melting or sintering one or more layers of material. System components and control may include a tool head configured to mill one or more portions of deposited material to improve formation of manufactured elements. Milling may be performed prior to hardening of material to remove excess or unwanted material prior to heating and bonding with additional layers.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

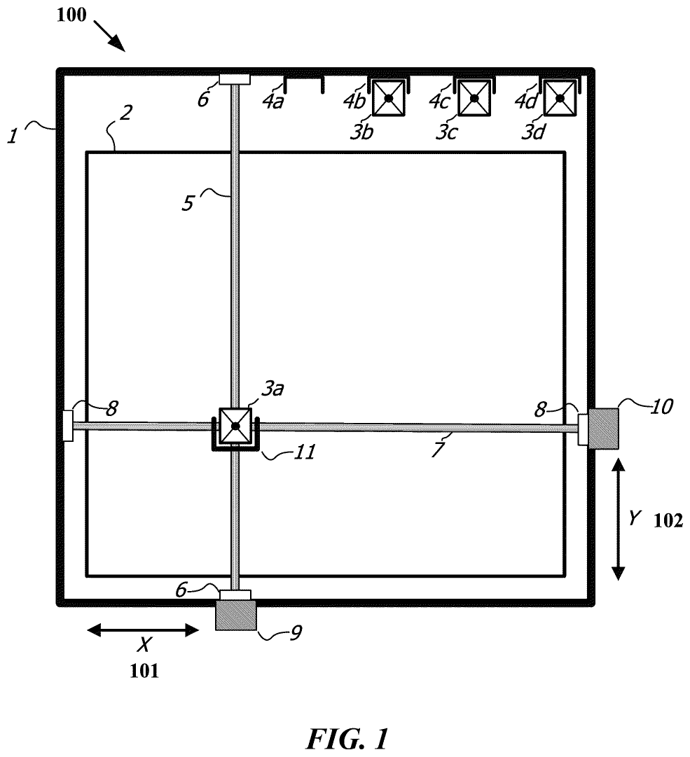

FIG. 1 is the top view of 3D printer configuration according to one or more embodiments. According to one embodiment, 3D printer configuration 100 includes at least one tool head configured to deposit material, such as extruded filament, at least one optical head to heat deposited material (e.g., debind, sinter, melt), and components to allow for head selection and control of printing. 3D printer configuration 100 may be configured for multimaterial printing, with a first tool head configured to extrude a first material, and a second tool head configured to extrude a second material. Tool heads of 3D printer configuration 100 may include at least one optical heating head for at least one of heating, debinding, sintering and melting deposited material. 3D printer configuration 100 may also include one or more elements to monitor heating, such as a camera to generate image data. 3D printer configuration 100 may also include a tool head for milling deposited material. In addition, 3D printer configuration 100 may include one or more elements to dilute, redirect and filter air in a printing chamber of 3D printer configuration 100.

3D printer 100 of FIG. 1 includes frame 1, to which a plurality of the 3D printer mechanisms may be attached and/or stored according to one or more embodiments. Frame 1 represents walls of a chamber of 3D printer 100 for enclosing deposited material. 3D printer 100 includes a horizontal rail 5, which can move left or right in the X direction (shown as 101). Attached to rail 5 are two bearings 6, which allow the horizontal rail 5 to slide left or right. On one end of horizontal rail 5 is a motor 9, which moves horizontal rail 5 left or right as the motor 9 spins clockwise or counterclockwise.

3D printer 100 includes vertical rail 7 which can move up or down in the Y direction (shown 102). Attached to rail 7 are two bearings 8, which allow the vertical rail 7 to slide up or down. On one end of vertical rail 7 is a motor 10, which moves vertical rail 7 up or down as the motor 10 spins clockwise or counterclockwise.

3D printer 100 may include carriage 11 configured to retain one or more tool heads, and for docking and removing tool heads from frame 1. Carriage 11 is attached to both horizontal rail 5 and vertical rail 7 such that carriage 11 can move to any X and Y position as the horizontal rail 5 and vertical rail 7 change positions. According to one embodiment, carriage 11 can attach and detach to one of a multiple of tool heads.

In FIG. 1, carriage 11 has tool head 3a (e.g., a first tool head) attached. Tool head 3a may include a heater and filament extruder, where filament is drawn into the extruder, heated by a heater to a liquid or softened state, then the heated filament is extruded through a nozzle onto at least one of build plate 2 or onto a previously extruded and solidified layer of the object being printed.

FIG. 1 shows a tool holder 4a, attached to the printer frame 1, which holds tool head 3a when the tool head is not being actively used. Also shown is tool holder 4b, attached to the printer frame 1, which holds tool head 3b when that tool head is not being actively used, tool holder 4c, attached to the printer frame 1, which holds tool head 3c when that tool head is not being actively used, and tool holder 4d, attached to the printer frame 1, which holds tool head 3d when that tool head is not being actively used. Although FIG. 1 shows four tool holders, it should be appreciated that 3D printer 100 may include fewer or additional tool heads and tool holders.

According to one embodiment, 3D printer 100 is configured such that one or more tool heads can be removed from respective tool holders and attached to carriage 11, which could then move the tool head over the object to be processed or extruded. When the processing or extrusion steps are complete, the tool head could be detached from the carriage 11, returned to its holder, and another tool head could be selected, by removing it from its holder and attaching it to carriage 11. 3D printer 100 may include a tool head for each material to be printed. Accordingly, separate tool heads may be employed for multimaterial printing. In addition, a milling head of a 3D printer 100, such as tool head 3c, for example, may be configured to remove excess material, and an optical head of a 3D printer 100, such as tool head 3d, may be configured to heat and debind or sinter/melt deposited material.

In embodiments, 3D printer 100 includes multiple tool heads. One or more of the tool heads would be composed of a filament heater and extruder. Each heater/extruder would be used for one type of filament, such as a plastic filament, or a metal based filament, or a support material filament. One type and size of filament would be fed into each heater/extruder tool head.

In addition to the one or more heater/extruder tool heads, 3D printer 100 can include one or more optical heating heads. The optical heating head would focus a beam of light from a laser or other intense light source to heat up the deposited layer at a spot. The light beam would be focused so that the spot of light would have a similar size or a smaller size of the width of the deposited layer. Multiple light output configurations may be controlled based on characteristics of deposited material (e.g., type, size, etc.).

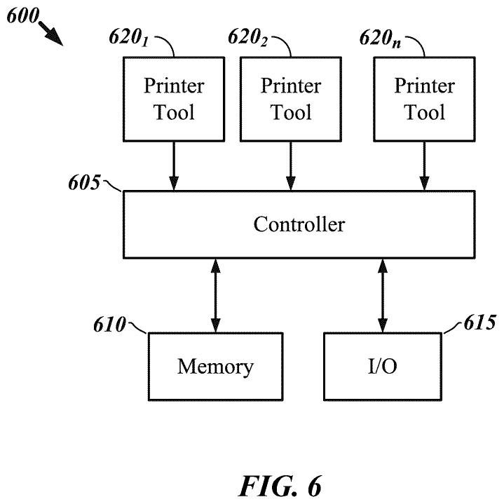

According to embodiments, one or more components of 3D printer 100 can be controlled by a controller (e.g., controller 605 of FIG. 6). In addition to control of tool heads, the controller may collect location information and data from the application of a layer that can be used to control position. Light beam power of one or more optical tool heads may be controlled differently based on material type or thickness. According to embodiments, optical head 3d is mechanically controlled in a similar way that a filament head is controlled. For example, 3D printer 100 may be configured as having independent heads, where each head is held on a carriage 11 which can move independently in the X or Y directions. Alternatively, 3D printer 100 may have a single carriage 11 which can hold one tool head at a time selected from a set of multiple tool heads. The movement of the carriage 11 can be controlled by belts, gears, or leadscrews actuated by stepper motors or other types of motors. According to embodiments, one or more of the heads could hold a laser assembly with a particular power or wavelength. 3D printer 100 may include a laser assembly including a laser diode, or a laser beam guided by an optical fiber or a set of mirrors, which may be in combination with optical lenses or other optical components. The laser beam's output power would be electronically controlled and adjusted depending on a variety of factors including one or more of type of deposited material, material thermal conductivity, material light absorption behavior, melting point, thickness, width, the amount and type of binder material, the desired quality of the processed material, and speed of motion of the carriage 11 holding the optical head. 3D printer 100 may be controlled to account for different heating characteristics. For example, one material may absorb more light than another material, so the material that absorbs more light will tend to heat to a higher temperature given the same amount of light. Similarly, materials with higher melting temperatures and higher thermal conductivity, deposited thicker and wider, will generally require higher amounts of laser power or slower movement of the laser head. As another example, heating the deposited material more slowly with a lower power during the debinding process would take longer but may result in less cracking and thus a higher quality material layer. 3D printer 100 may be configured to store a sequence of changes of the X, Y, and Z position of the carriage 11 and the laser beam power specified using computer code, such as a computer file. According to embodiments, a computer file may be used by 3D printer 100 to specify the locations and possibly the peak movement velocity or peak movement acceleration, but not the instantaneous velocities of moving from one position to the next position. The actual instantaneous velocities of moving from one position to the next position would be different from one printer to another, based on the mechanical implementation, such as the power of the motors or the mass of the carriage. According to embodiments, laser beam power can be dynamically adjusted by measuring the instantaneous movement speed of the carriage 11 holding the laser head so that the temperature of the illuminated deposited material would be the same whether the laser head was moving slowly or quickly or accelerating or decelerating. The laser beam power may need to be adjusted many thousands of times per second when the laser beam is moving quickly. The instantaneous movement speed of the carriage 11 holding the laser head could be measured using an accelerometer, or measured using command or position information from motors 9 and 10.

According to embodiments, 3D printer 100 is configured for a debinding process and sintering/melting process to occur in the 3D printer itself. As such, separate or additional debinding equipment or a sintering oven are not needed. This eliminates the manual steps of moving the object from the 3D printer, to the de-binding machine, and then to the sintering oven. In addition, costs of a separate de-binding machine and the sintering oven may be avoided.

According to one embodiment, 3D printer 100 includes a chamber that can be tightly scaled to keep atmospheric oxygen from entering from outside the chamber and reacting with reactive metals such as aluminum, magnesium, titanium, or steel when the metal layers are being heated by the optical beam. The chamber of 3D printer 100 could be filled with an inert gas before printing starts, or a jet of inert gas could be blown over the layer at the spot being heated by the optical beam. According to embodiments, inert gases may be used in 3D printer 100 which are least reactive with hot metals would be noble gases such as helium and argon. Other gases such as nitrogen or carbon dioxide might also be used, although the strength of the 3D printed metal may not be as strong as when helium or argon are used because those gases may still react slightly when the deposited material is heated by the laser light beam. According to embodiments, inert gas may be directed through a nozzle in the vicinity of where the laser beam illuminates the material whenever the expected temperature is high enough to react with any oxygen, preventing any chemical reaction. According to embodiments 3D printer 100 may include a flexible tube connecting the inert gas nozzle to the laser optical head on one end, and the inert gas source on the other end. The shape of the inert gas nozzle may be a simple tube or a flattened tube, and may be angled or coaxially surrounding the optical beam optics. In addition to preventing chemical reactions of the heated metal, the inert gas may be used to blow away any smoke or volatile chemicals emitted by the heated binder material from being deposited on the optical surfaces of the laser focusing lens or any camera lens. According to embodiments, 3D printer may include a vacuum tube and nozzle, which may be at a fixed position in the chamber or attached to the optical tool head or both, to remove any smoke or volatile chemical emissions from the chamber. The removed gases could be filtered and the cleaned gases could be returned to the chamber or could be exhausted outside of the chamber.

According to embodiments, 3D printer 100 may be configured for 3D printing using metal or ceramic based filaments, such as filaments made having metal or ceramic powder mixed with a small amount of binder material. The filament mixture can be melted and extruded, and deposited into a thin layer. The binder material keeps the fine powder bound into the filament. By keeping metal powder physically bound into a filament, handling hazards of free metal powder are greatly reduced or eliminated.

According to embodiments, 3D printing processes described herein include removal of binder material after material is deposited by was of debinding such that the binder material is removed from the raw metal or ceramic. Unlike conventional filament based metal 3D printers that moved fabricated parts to a separate debinder machine, such as operations that submerge whole parts in chemicals to slowly dissolve the binder or placing whole parts in an oven to slowly bake out the binder, operations are described herein for heating by an optical or laser source for each deposited layer. Using an optical source according to embodiments reduces time to debind and prevents melting, cracking, or warping of parts. In addition, use of an optical heating head according to embodiments can allow for use of different metals or ceramics together in the same print. In addition, operations described herein allow for addressing one or more defects of deposited material, such as porous surface which can cause a part to shrink, often by different amounts in the X, Y, and Z directions. Embodiments also improve printing within specification of final desired dimensions by avoiding placement of an entire structure in a separate heating environment.

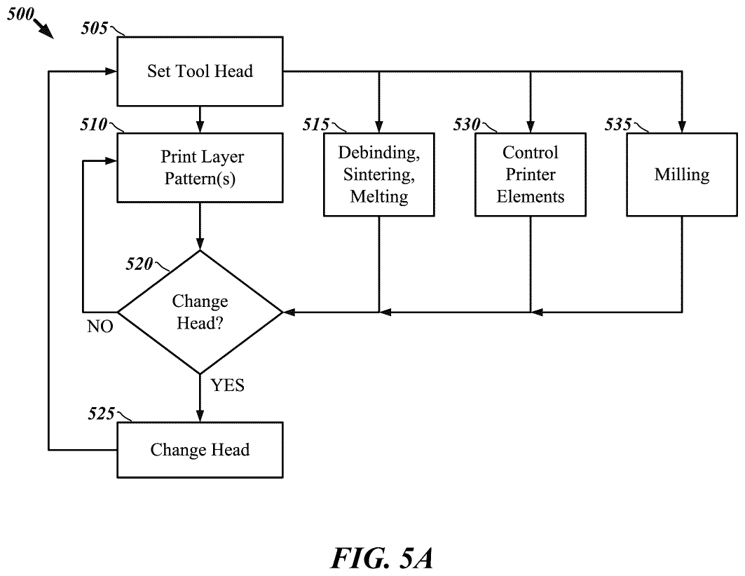

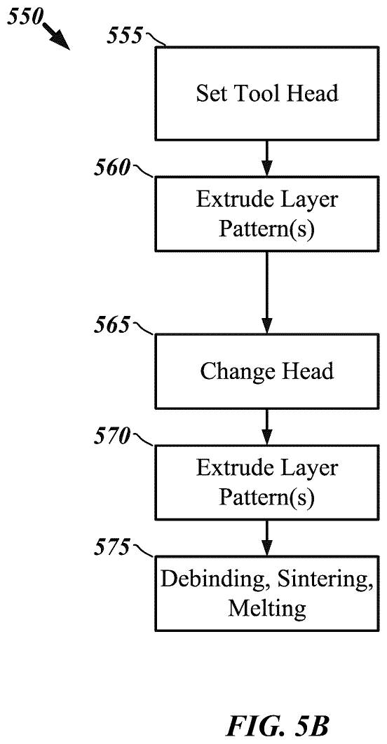

According to embodiments, 3D printer 100 can perform a plurality of manufacturing processes including 3D printing of a single material and multimaterial 3D printing. 3D printer 100 may be operated using one or more processes described herein, including processes described in FIGS. 5A-5B. According to an exemplary embodiment, 3D printer 100 may be configured to perform multimaterial 3D printing such that one or more layers of a first material (e.g., material A) are extruded and one or more layers of at least one additional material, such as a second material (e.g., material B), are 3D printed. Deposited material can may be heated to form an integrated structure. An exemplary scenario is provided for operations to be controlled by a controller of a 3D printer using one or more computer executed instructions, such as a control file. By way of example, one layer of material A is extruded with a particular width and nominal thickness from extrusion head 3a in a pattern specified by a control file used by a controller. The width of material A is set by the diameter of the extrusion nozzle of extrusion head 3a, the diameter of filament 13a, and the speed at which filament 13a is fed into extrusion head 3a. The nozzle diameter and filament diameter are both selected by installing the desired nozzle and filament into the 3D printer at the start of the printing process. The speed of the filament moving into extrusion head 3a is determined jointly by the control file and how the 3D printer accelerates and decelerates the motion of the extrusion head 3a. The nominal thickness of the material A pattern is determined by the control file, which can change the separation of extrusion head 3a from print bed 2 by the nominal thickness just prior to the start of printing each layer. When the layer pattern for material A is completely extruded, a second material B can be printed. In a tool changer configuration of 3D printer, the printer can have multiple tool heads, and only one tool head can be selected and can be active at a time. As an example, in one type of tool changer 3D printer configuration, extrusion head 3a can be removed from the carriage 11 and placed in tool holder 4a by moving the carriage to position of tool holder 4a and unlocking extrusion head 3a from the carriage. According to embodiments, a magnet would hold extrusion head 3a into tool holder 4a when unlocked from the carriage. Empty carriage 11 could pick up extrusion head 3b by moving to tool holder 4b and locking extrusion head 3b to carriage 11. The process of moving the carriage 11, unlocking and locking the extrusion heads 3a and 3b would be specified by the control file. Once the carriage 11 has extrusion head 3b locked to it, the material B pattern can be printed. When material B has been added to the layer or output as a pattern/printed, extrusion head 3b can be moved to tool holder 4b and unlocked from carriage 11. Then carriage 11 could be moved to tool holder 4c to pick up another tool, such as a rotary grinder head 3c, which could be used to mill (e.g., grind, smooth, etc.) at least one portion of a layer, such as peripheral surface of deposited material A and material B. Grinder head 3c may be coupled to power generator 36 through power cable 35. This grinding process can smooth away layer line steps or peripheral surface roughness caused by bits of material stuck to the nozzle occasionally being deposited on the peripheral surface. Since the grinding is done before the materials have been heated for debinding or melting, the extruded material is still soft and can be ground away more easily. Dust particles generated by the grinding process can be vacuumed up by vacuum nozzle 25 and filtered by filter 27. When the peripheral surface has been smoothed, the rotary grinder head 3c can be replaced by light emitting element such as optical heating head 3d, which can be controlled to heat the deposited layer. For highest processing quality, optical heating head 3d can illuminate the deposited layer at a moderate intensity to heat the layer to a temperature that would be just high enough to evaporate or decompose the binder material. Because the deposited layer is likely to be thin, typically less than 200 microns, the heating time can be short. Light emitting head 3d could travel over the same path as extrusion head 3a did when it deposited material A. Once that pattern has been debinded, optical heating head 3d can travel over the same path as extrusion tool head 3b during deposition of material B. Material B might have a different binder or different light absorption property. According to embodiments, optical heating head 3d may be controlled to modify light intensity according to one or more characteristics of material B. As such, 3D printer may provide multiple light pulse processing configurations. After the entire layer has been debinded, optical heating head 3d could travel over the deposited material A pattern again, but with a higher intensity which would be appropriate for sintering or melting. For sintering, the temperature would need to be high enough for the material particles to fuse together where the particles touch each other, but not so high that the material particles wholly melt. For melting, the temperature would need to be high enough for the material particles of the top deposited layer to melt to each other and melt partially into the next lower layer, but not so high that multiple layers would wholly melt. If the melted area goes too deeply, it can cause the object shape to become distorted. Processing time can be saved by combining the debinding heating and the melting heating together in one step, but the processing quality may be lowered because too much gas is emitted too quickly when the debinding material is heated, resulting in cracking and voids which lower the object's strength.

Although FIG. 1 is described as using filaments, it should be appreciated that principles of the disclosure may be applied to 3D printing based on binder jetting and pellet extrusion, in addition to filament extrusion. A binder jetting 3D printer normally does not use a laser in the printing process. According to embodiments, a binder jetting process by 3D printer 100 can include depositing a thin layer of powder, such as metal or ceramic powder, onto the entire print bed. Then small droplets of liquid binder are deposited in the desired pattern onto the surface of the print bed. The process of depositing a layer of powder, then “jetting” the binder onto the powder is repeated until the entire object has been printed. The powder that had no binder jetted onto it will not adhere to the object. The full object can then be heated to debind and sinter the metal powder particles together. 3D printer 100 may be configured to use pellet extrusion similar to a filament based 3D printer where material fed into the printer is heated, melted, and extruded through a nozzle onto the print bed. However, the material fed into the printer is not in the form of a long fixed diameter filament wound in a spool, but instead is in the form of pellets or beads. The pellets may be forced into the hot extruder using a rotating screw mechanism. 3D printer 100 may be configured to utilize a high intensity light pattern to heat each layer before the next layer is deposited.

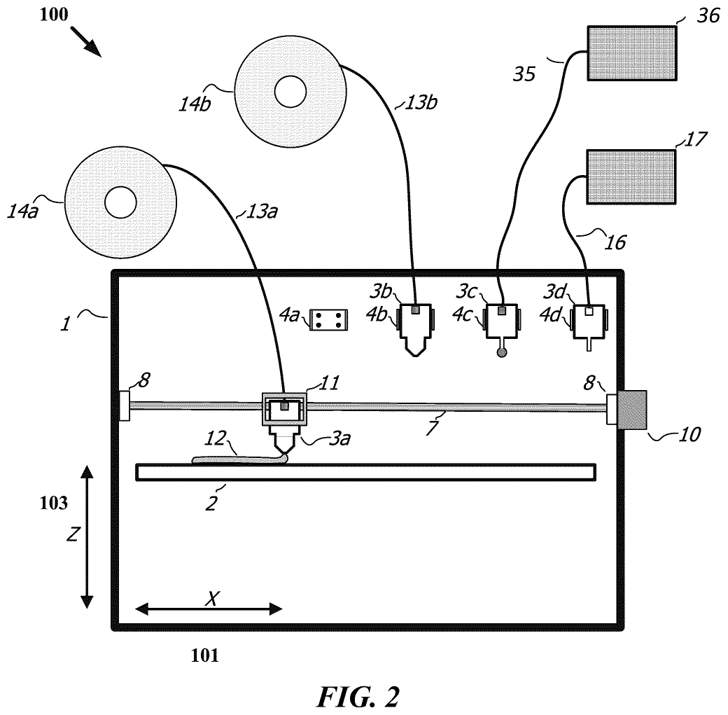

FIG. 2 is a front view of 3D printer 100 according to one or more embodiments. FIG. 2 illustrates extrusion of melted material to make an object. In FIG. 2, tool head 3a is attached to carriage 11 and is configured to move toward the right in the X direction (shown as 101) to deposit material. Filament 13a may be unrolled by 3D printer 100 from spool 14a into tool head 3a, where the filament is heated and extruded onto the build plate 2 in one or more layer patterns. Similarly, filament 13b may be unrolled by 3D printer 100 from spool 14b into tool head 3b. After each layer of the object is printed, the bed 2 can move downward in the Z direction (shown as 103) so that the next layer is extruded onto the previous layer. Operations for changing tool heads may be performed similar to tool head changes described with reference to FIG. 1.

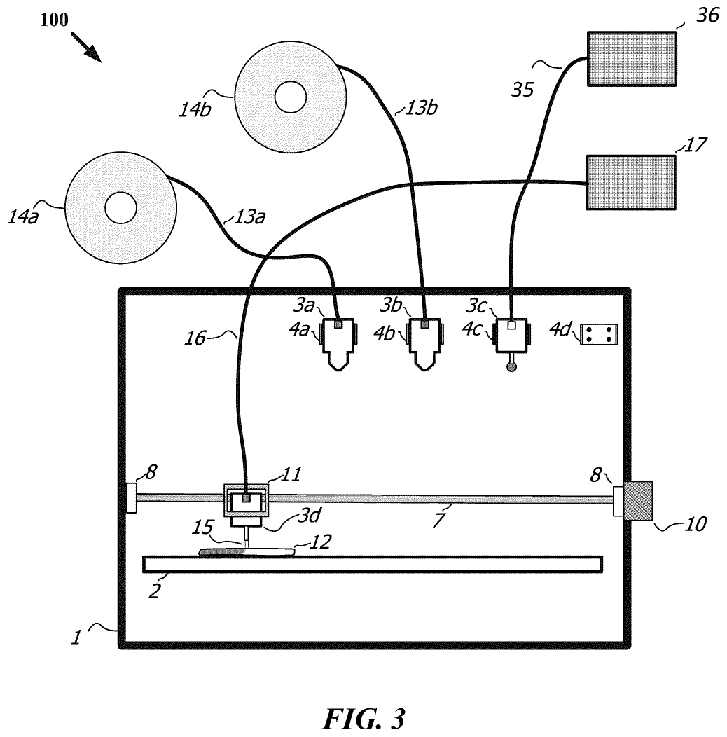

FIG. 3 is a front view of the printer, showing an optical heating head passing over the extruded material according to one or more embodiments. FIG. 3 shows tool head 3d attached to the carriage 11. In this example, tool head 3d is the optical heating head. Optical tool head 3d may be configured to perform an optical heating operation and connect to optical power generator 17 through optical power cable 16. Optical tool head 3d may be an optical heating head configured to output a focused laser light beam. Optical tool head 3d may be controlled by a controller of the 3D printer to control output of the laser light beam including control of laser light beam focus, laser light beam size, and laser light beam speed of movement. According to one embodiment, the optical tool head can include a focusing lens (e.g., focusing lens 20). According to embodiments, focusing lens includes anti-reflection coating to keep the high power laser light from being absorbed by the lens and overheating the lens. According to embodiments, the focusing lens may be angled a few degrees from vertical, so that light reflected back from the extruded layer 12 will not reflect directly back into the laser diode. By providing a powerful light beam with a light wavelength that is easily absorbed by the material to be heated, the optical tool head can be moved quickly and thus improve time to debind, sinter, and/or melt the extruded material.

Tool head 3d may be moved horizontally (in FIG. 3 with respect the X axis) to trace over the previously extruded layer 12, and tool head 3d can emit an optical beam 15 to heat a spot of the previously extruded layer 12. The intensity of the optical beam 15 may be adjusted to account for the speed of the spot movement, so that the temperature of the heated spot of the previously extruded layer 12 reaches the desired temperature for the desired step of de-binding, sintering, or melting. The speed of the spot movement may also be adjusted for the desired heating duration or desired time and temperature profile.

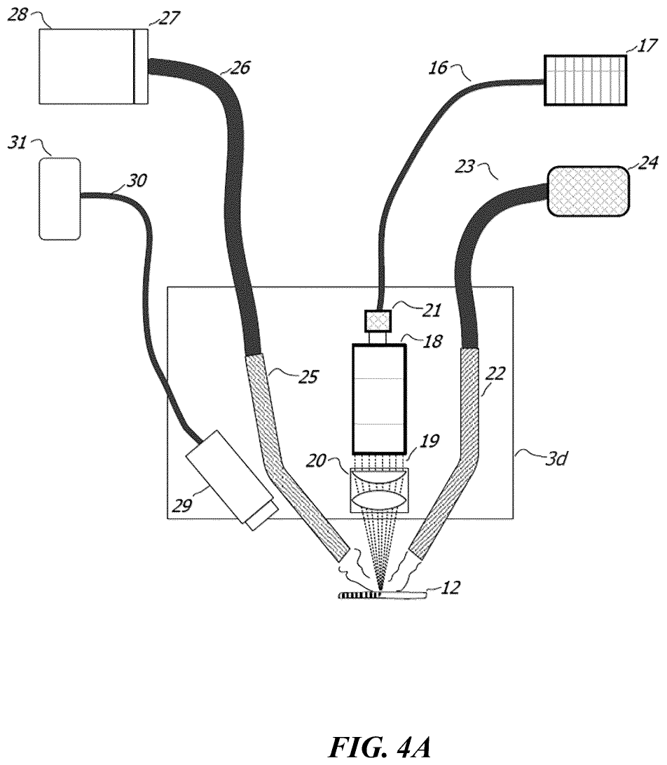

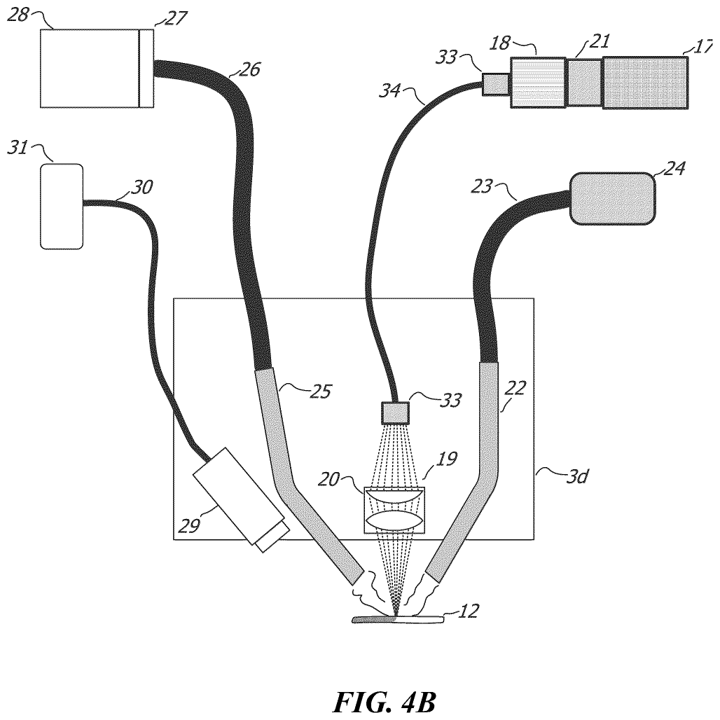

FIG. 4A shows an arrangement of components of an optical heating head 3d. According to one embodiment, a light emitting component 18 (e.g., a laser diode or other type of source) can generate an intense beam of light 19, which may be a laser light beam. Beam of light 19 can pass through lens assembly 20, which focuses the beam into a small circular spot. According to embodiments, the power of the light beam of light emitting component 18 can be modulated using amplitude modulation of the laser diode current, or pulse width modulated, where the laser diode current is rapidly switched on and off. According to embodiments, amplitude modulation with pulse width modulation may be combined for generating laser light beams, giving finer control of the light beam's power and thus finer control over the temperature of the heated material. FIG. 4B shows another arrangement of components of an optical heating head 3d, where a light emitting component 18 is attached to laser diode driver device 21 and then to laser control circuit 17 rather than being part of optical heating head 3d. In this embodiment, the light beam emitted from light emitting component 18 is transmitted to optical heating head 3d through a fiber optic assembly consisting of fiber optic cable 34 with fiber cable couplers 33 on each end of the cable.

According to one embodiment, lens assembly 20 may consist of one or more lens elements of different shapes. It is possible that the light emitting component 18 can emit a rectangular beam of light. In this case, one of the lens elements of lens assembly 20 may have a cylindrical shape, in order to shape the beam of light into a circular shape. With an appropriate choice of lenses, the light beam 19 can be focused into a small circular beam, where the diameter of the beam could match the width of the deposited layer 12.

As shown in FIG. 4A, an optical tool head can include a laser diode driver device 21, which generates a controlled electrical current for light emitting component 18. Laser diode driver device 21 is connected to a laser control circuit 17 through electrical cable 16. Laser control circuit 17 generates a modulated control signal, using pulse width modulation, amplitude modulation or other modulation, which changes the power of light beam 19 based on the movement speed of optical heating head 3d.

As shown in FIG. 4A, an optical tool head can include a vacuum nozzle 25 which is connected to filter 27 and vacuum pump 28 through the flexible vacuum hose 26. Vacuum nozzle 25 could be used to vacuum up smoke or vaporized binder material that may be generated as part of the debinding step or to vacuum up dust particles generated by a rotary grinder or milling tool head (e.g., tool head 3c). The smoke, vaporized binder material, or dust particles could be sent through a filter 27, which could absorb or adsorb dust, smoke, or volatile organic compounds which could be a health hazard. Filter 27 may be controlled for at least one of diluting, redirecting and filtering air in a printing chamber to remove fumes when optically heating deposited filament.

As shown in FIG. 4A, an optical tool head can include an inert gas nozzle 22 which connects through flexible tube 23 to an inert gas dispenser 24. When the light power of light beam 19 is used to melt the deposited layer 12, the metal particles in deposited layer 12 may react with oxygen in the air. The chemical reaction may affect the strength or other characteristic of the metal layer. By emitting inert gas from nozzle 22 over the heated area of deposited layer 12, the heated metal particles may be shielded from any undesirable chemical reactions with the air.

In embodiments, the optical tool head includes optics to generate a light beam spot, and also have an inert gas nozzle 22, a vacuum nozzle 25, and a camera 29. The inert gas nozzle 22 may be used when a metal layer is being heated. An inert gas, such as carbon dioxide, nitrogen, argon, or helium would be emitted over the heating spot position, to keep the metal from reacting with oxygen in room air when the metal is heated to sintering or melting temperatures. According to embodiments, inert gas may be obtained from a compressed gas cylinder, but might also come from a nitrogen gas atmospheric extractor. The inert gas may be heated before being emitted from the nozzle 22 to match the temperature of the existing gas in the print chamber. The gas may be heated by a combination of heat exchanger and electrical heater.

The vacuum nozzle 25 may be used to remove any gas or smoke released when heating the deposited layer, and to send the vacuumed gas to HEPA (High Efficiency Particulate Air) and VOC (Volatile Organic Compound) filters. As such, elements of a 3D printer according to embodiments can prevent vaporized material from being deposited onto mechanical or electronic components inside the print chamber, and can prevent noxious fumes or odors from being emitted from the printer.

As shown in FIG. 4A, an optical tool head can include camera 29, connected to a computer 31 through a flexible cable 30. The camera could be focused on the area where deposited layer 12 is being heated or has been heated in order to monitor the quality of the de-binding, sintering, or melting step. Camera 29 may be configured to be focused on the position of the light beam spot. Camera 29 may be configured to output image data, such as camera images, to a controller, the image data my a be used to adjust the focus and position of the light heating beam to provide the correct placement of the beam. The images from camera 29 could also be used to inspect one or more areas and deposited material before heating, and after heating. By way of example, camera may be configured to perform an inspection after deposition but before heating to identify gaps in certain places of the deposition. In such a case, the deposition step could be repeated in a defective area to fill any gaps. According to embodiments, the deposition may be inspected after the layer has been heated, to look for gaps or to determine if a melting step did not reach the melting temperature. By way of example, a smooth and shiny layer surface may indicate that the melting temperature has been reached, and a bumpy or discolored layer surface may indicate that the melting temperature was not reached. If necessary, the light beam's power could be adjusted and then the heating step repeated.

One or more components of the optical tool head of FIG. 4A may be embodied in other tool heads.

The light beam generated by an optical tool head could have an adjustable focus so that the focused beam could be made larger or smaller. For instance, the extruded layer may become narrower or wider than normal because of under or over extrusion. Under-extrusion may occur when the gap between the extrusion head and the previously deposited layer is higher than normal, or when the filament is fed slower than normal, or when the filament extrusion rate is too low for the print tool head movement. Over-extrusion may occur when the gap between the extrusion head and the previously deposited layer is lower than normal, or when the filament is fed faster than normal, or when the filament extrusion rate is too high for the print tool head movement. According to embodiments, the same optical tool head could be used with multiple extruder tool heads, each extruder with a different nozzle size. In this situation, a single optical tool head could change the size of the light beam by changing the focus. For instance, the smallest diameter and highest concentration of light of the light beam spot would occur at the exact focus distance between the optical tool head lens 20 and the extruded surface. Raising or lowering the optical head from the exact focus distance would increase the light beam spot diameter, while lowering the concentration of light. The power profile of the spot beam may be different whether the optical head is higher or lower than the exact focus distance. For instance, depending of the optics, in the higher position the center of the spot may be more intense while in the lower position the spot may be more intense at the edge of the spot. It may be advantageous to use one position over the other based on the heating properties of the material. In normal operation, the distance of the optical tool head to the extruded surface would be adjusted so that the diameter of the beam spot would match the width of the extruded material, and camera 29 could be used to verify the size match.

According to embodiments, a 3D printer as described herein can include multiple optical heating heads. In one embodiment, a 3D printer may include a narrow beam optical heating head to match a narrow layer extrusion width, and a wide beam optical heating head to match a wide layer extrusion width. According to another embodiment, a 3D printer may include multiple laser heads with different wavelengths for different materials, since some metal or ceramic powders may absorb different amounts of light at different wavelengths of light.

An optical tool head as described herein can control light beam intensity to be adjusted to heat the deposited layer to a desired temperature. The light beam intensity might be adjusted to different power levels based on the material's reflectivity or based on the speed of the optical heating head movement. In addition to having a variable continuous beam intensity, it is possible to have variable pulses of beam intensity, or a mix of continuous and pulses of beam intensity. In the case of variable pulses, the intensity of the beam peaks and the pulse widths could be adjusted.

According to one embodiment, an optical tool head may be configured for heating deposited material and/or layers in order to implement the debinding and sintering or melting process. According to embodiments, a heating process may be used that is implemented in two passes, where the debinding step is implemented in one complete pass, and then metal melting and ceramic sintering step may be implemented as a second complete pass. Alternatively, the debinding and sintering or melting process could be implemented in a single pass, where the laser spot position would be advanced to one spot, then illuminated with a certain intensity and duration to implement the debinding process, then illuminated again with a different intensity or duration to implement the sintering or melting process. Additional passes for the debinding step or the melting/sintering step may be made if necessary to correct defects or to improve the quality of the sintering or melting step.

Plastic material may not need a debinding step or sintering step, although it might be beneficial to reheat the just deposited plastic layer in order to improve layer to layer adhesion, and/or to reduce mechanical strain that may cause the part to warp.

Configurations for a 3D printer as described herein, such as 3D printer 100, provide advancements and improvements to 3D printing. By way of example, with mixed material 3D printer design described herein, there is no need for additional equipment or processing steps for binder material removal or high temperature sintering equipment post fabrication. According to embodiments, binder material is removed while in the printing chamber after each layer is deposited. After each layer's debinding, remaining metal particles within 3D printer 100 are sintered or melted together or the ceramic particles are sintered or vitrified, by an optical head. Since the debinding and melting may be performed for each layer, the overall part does not shrink significantly. Any shrinkage may be mostly confined to a single layer, and would then be overlaid with the next deposited layer, correcting any shrinkage.

FIG. 5A illustrates a process for 3D printing according to one or more embodiments. According to one embodiment, a 3D printer (e.g., 3D printer 100) may be configured to perform process 500 for mixed material 3D printing. One or more operations of Process 500 may be controlled by a device, or controller (e.g., controller 605). Process 500 may be initiated by setting a tool head at block 505. Setting a tool head may relate to selection of a tool head (e.g., tool head 3a) in a carriage (e.g., carriage 11) to allow for positioning of the tool head and deposition of material. At block 510, the tool head may be controlled to print one or more layers. According to embodiments, a printing sequence would be to first extrude a layer of melted filament on to the print bed or to a previous layer in the desired pattern. If there is a second type of filament material to be extruded for the same layer, the tool head would be changed to the next filament material type, and this next material would be extruded into the desired pattern. If there are additional types of filament material to be deposited for that layer, the process would repeat for each material.

Layer patterns and layer characteristics may be controlled by a controller of the 3D printer. Process 500 may include determining whether to change a tool head at block 520. When the current tool head does not need to be changed (e.g., “NO” path out of decision block 520), one or more additional layer patterns may be printed at block 510. When the current tool head does need to be changed (e.g., “YES” path out of decision block 520), the tool head may be changed at block 525. Process 500 may then set the tool head at block 505, such as an optical head, or a milling tool head at block 505. For instance, once the extrusion of each material for all of the layer patterns is complete, the tool head, if controlled by a controller, would be changed to the optical heating head. If necessary, the optical heating head height could be moved up or down to increase or decrease the laser spot size to match the extruded material at block 530. The optical heating head may be controlled to retrace the paths of the various materials for the layer. The controller may be configured to retrace the same path and in the same order as the various materials were deposited for the layer, and other retracing patterns may be performed. For some materials, such as metals or ceramics, the path for that material might be retraced once or twice, in order to heat the material to the debinding temperature, and to heat the material to the sintering or melting temperature.

Process 500 may include performing optical heating for debinding, sintering, and/or melting at block 515, mechanical milling at block 535, and controlling one or more printer elements at block 530. Debinding, sintering, or melting at block 515 may include control of an optical heating head including one or more of beam strength, beam width, optical head speed, etc. The deposited material (e.g. deposited material 12) may be a mixture of metal or ceramic powder combined with a binder material such as plastic that holds the powder and binder mixture in a paste-like form so it will hold its shape. The binder should be removed prior to any sintering or melting step. According to embodiments, debinding of the deposited layer include heating at least a portion of the layer with the laser beam to a temperature where the binder material will boil away, or thermally and chemically decompose. Debinding can include control of the laser light beam to heat each layer of deposited material before depositing an additional layer. For sintering, which may be used for ceramic materials, the temperature would need to be high enough for the material particles to fuse together where the particles touch each other, but not so high that the material particles wholly melt. For melting, which may be used for metal materials, the temperature would need to be high enough for the material particles of the top deposited layer to melt to each other and melt partially into the next lower layer, but not so high that multiple layers would completely melt. According to embodiments, heating of deposited material is monitored using camera image data. For example, monitoring can include inspecting deposited material for defects (e.g., gaps, incorrect deposition, etc.). Control of printer elements at block 530 may include control of a camera, infusion of gas, removal of particulates/gas, vacuuming, etc.).

According to embodiments, once material is extruded relative to a print bed or other layer, a 3D printer may be controlled to heat the deposited material using an optical heating head. By way of example, a controller can control at least one optical heating head to generate a laser light beam to heat deposited material and control the optical heating head to heat deposited material to debind the deposited material. The optical heating head may also be controlled to sinter debinded material. The light beam from the optical heating head would be modulated to heat the deposited layer to the appropriate temperature. The intensity of the light beam could be adjusted depending on the material, the size of the light beam, and the speed of the light beam's movement. The duration of the light beam heating could also be adjusted. The combination of light beam power and duration could be adjusted to generate a metal or ceramic layer with the desired smoothness, strength, heating depth, or other properties. The controller may control emission of an inert gas over the heated area in associated with heating of deposited material. According to embodiments, operations of the 3D printer, such as depositing material and heating may be monitored by camera image data and a laser light beam. By way of example, an optical tool head (such as optical tool head 3d) may include a camera and/or imaging device and include a laser light source. Camera image data may be received by the controller and used to adjust focus and power of the laser light beam.

In FIG. 5A, milling at block 535 may be mechanical milling, such as grinding of at least a portion of a layer or deposited material. Milling may be optional. Milling at block 535 may be where a high quality surface finish or high dimensional accuracy of the object is desired. According to embodiments, it may be advantageous to perform milling after debinding but before sintering or melting, when the layer is still has a paste-like consistency which makes it easier to machine.

According to one embodiment, process 500 may print one or more patterns of a layer at block 510 based on one or more of binder jetting, pellet extrusion and filament extrusion. With pellet extrusion, the material to be deposited is not in filament form but in the form of pellets. A tool head may include a screw mechanism or other feed mechanism to feed pellets for heating. The melted material may then be extruded out of a nozzle. Tool heads as described herein may also extrude rods of material, rather than filament or pellets. By way of example rods may be fed into an extruder head configuration that pushes each rod into a heater to melt the rod material. The melted material would then be extruded out of a nozzle of a tool head. According to one embodiment, debinding at block 515 may include use of a high intensity light pattern to heat each layer before a next layer is deposited. Since a layer may have different materials, it may be necessary to adjust the light beam power and intensity, or adjust the movement speed of the optical heating head differently when retracing over each type of material in a layer. According to one embodiment, at least one of a first intensity and beam pattern may be utilized during a first pass of an optical heating head, and at least one of a second intensity and second beam pattern may be utilized for a second pass of the optical head relative to deposited materials where the intensities are matched to the material characteristics and to the type of heating for debinding, sintering, or melting. The intensities would also take into account the size of the beam, the movement speed of the beam. Beam patterns utilized may be based on high intensity light patterns for sintering or melting powder (e.g., without the binder).

By changing the tool heads, different materials could be deposited side by side within each layer. The laser might use two retrace passes to debind and melt metal or ceramic materials, while plastic materials of the layer might be left unheated or might have only one retrace path heated just enough to melt or soften the top layer of plastic in order to increase the layer to layer adhesion where the amount of heating could be determined by prior characterization of the plastic material's layer to layer adhesion. For instance, it would be possible to print an integrated part with metal in the center, surrounded by flexible plastic, where the metal provides a strong structure and the flexible plastic acts as a vibration damper or sound absorber. It would also be possible to print an integrated part with multiple kinds of metal, such as a heat exchanger pipe with an inner water cooled copper portion for heat transfer and outer walls made of stainless steel for strength.

FIG. 5B illustrates a process for 3D printing according to one or more other embodiments. According to one embodiment, process 550 may be performed by a device, such as 3D printer 100. In certain embodiments, process 550 may be directed by a controller, such as the controller of FIG. 6.

Process 500 may be initiated by setting a tool head at block 555. A first tool head for a first material may be set as the head by the 3D printer. At least one tool head may be selected and/or loaded to a carriage, such as an extruding head. At block 560, process 500 includes extruding one or more layer patterns to form deposited material. At least one layer pattern of melted filament may be extruded from the first tool head relative to at least one of a print bed and a layer to deposit material. The filament may include at least one of metal, plastic and ceramic.

At block 565, the tool head of the 3D printer may be changed to a second tool heard to extrude layers of a different material at block 570. At least one layer of melted filament from the second tool head may be extruded to deposit material relative to at least one of the print bed and deposited material. The first tool head and the second tool head are configured to print different materials to one or more layer patterns to form at least a portion of an integrated part.

At block 575, process 550 may include debinding, sintering, or melting one or more deposited layers of different material from the first and second tool heads. The optical head may be controlled to debind, sinter, or melt deposited material. The optical heating head may be controlled based on deposited material. Debinding, sintering, or melting may include outputting a focused beam of light by the optical head to debind material and fuse deposited material. Process 550 may include controlling milling of at least a portion of deposited material. Milling may be performed on extruded layers that have been debinded.

Process 550 may include performing one or more operations in conjunction with extruding and debinding. According to one embodiment, process 550 may include emitting an inert gas over the heated area to prevent metal powder particles from at least one of reacting or oxidizing in air in a printing chamber. According to another embodiment, process 550 may include removing noxious fumes when optically heating deposited filament. Process 550 may include monitoring the heating process with a camera. Process 550 may also include adjusting focus, size and/or power of a light beam of the optical head. Process 550 may also include adjusting power of a light beam of the optical head based on at least one of material, size of a light beam, and speed of light beam movement.

FIG. 6 is a device configuration according to one or more embodiments. According to one embodiment, device 600 illustrates one or more elements of a 3D printer (e.g., 3D printer 100). According to one embodiment, device 600 includes controller 605, memory 610, input/output block 615 and a plurality of printer tools 620₁₋ₙ.

Controller 605 may direct one or more components of a 3D printer (e.g., 3D printer 100) for 3D printing and multimaterial 3D printing. Device 600 includes printer tools 620₁₋ₙ which may include one or more tool heads, tool head motors, optical heads, etc. Printer tools 620₁₋ₙ can include a first tool head configured to deposit a material, and a second tool head configured to deposit a second material. Printer tools 620₁₋ₙ can include an optical head configured to debind, sinter, or melt deposited material. Printer tools 620₁₋ₙ can include one or more tool heads for milling, such as tool head 3c with holder 4c.

Controller 605 may relate to a processor or control device configured to execute one or more operations stored in memory 610, such as a 3D printing process described herein. Controller 605 may be coupled to memory 610, I/O 615 and printer tools 620₁₋ₙ. I/O 615 may be configured to receive one or more instructions for operating device 600.

According to one embodiment, controller 605 is configured to set/select the first tool head and control extruding of at least one layer of melted filament from the first tool head relative to at least one of a print bed and a layer to deposit material. Controller 605 is also configured to control a tool head change to a second tool head, and extrude at least one layer of melted filament from the second tool head relative to at least one of the print bed and deposited material. Controller 605 is also configured to control at least one optical heating head to debind deposited material, wherein the optical heating head is controlled based on deposited material.

While this disclosure has been particularly shown and described with references to exemplary embodiments thereof, it will be understood by those skilled in the art that various changes in form and details may be made therein without departing from the scope of the claimed embodiments.

What is claimed is:

1. A method for 3D printing, the method comprising:
setting, by a device, a first tool head;
extruding, by the device, at least one layer of melted filament from the first tool head relative to at least one of a print bed and a layer to deposit material;
controlling, by the device, at least one optical heating head to generate a laser light beam to heat deposited material, wherein the optical heating head is controlled to heat deposited material to debind the deposited material and wherein the optical heating head is controlled to sinter debinded material;
controlling, by the device, emission of an inert gas over the heated area in association with heating of deposited material; and
monitoring, by the device, heating of the deposited material using camera image data and the laser light beam, wherein control of the optical heating head includes using the camera image data to adjust focus and power of the laser light beam.

2. The method of claim 1, wherein the optical heating head is configured to output a focused laser light beam, and wherein control of the laser light beam includes control of laser light beam focus, laser light beam size, and laser light beam speed of movement.

3. The method of claim 1, wherein debinding includes control of the laser light beam to heat each layer of deposited material before depositing an additional layer.

4. The method of claim 1, wherein monitoring heating of the deposited material using camera image data includes inspecting deposited material for defects.

5. The method of claim 1, wherein emission of an inert gas is controlled to prevent metal powder particles from at least one of reacting and oxidizing in air in a printing chamber.

6. The method of claim 1, further comprising at least one of diluting, redirecting and filtering air in a printing chamber to remove fumes when optically heating deposited filament.

7. The method of claim 1, further comprising milling deposited material prior to heating deposited material.

8. The method of claim 1, further comprising controlling, by the device, a tool head change to a second tool head, extruding, by the device, at least one layer of melted filament from the second tool head relative to at least one of the print bed and deposited material, wherein the first tool head and the second tool head are configured to print different materials to form at least a portion of an integrated part.

9. The method of claim 1, further comprising adjusting at least one of focus, size and power of a laser light beam of the optical head.

10. A device configured for 3D printing, the device comprising:
a first tool head configured to deposit a material;
an optical head configured to heat deposited material; and
a controller configured to
set the first tool head;
control extruding of extruding of at least one layer of melted filament from the first tool head relative to at least one of a print bed and a layer to deposit material;
control at least one optical heating head to generate a laser light beam to heat deposited material, wherein the optical heating head is controlled to heat deposited material to debind the deposited material and wherein the optical heating head is controlled to sinter debinded material;
control emission of an inert gas over the heated area in association with heating of deposited material; and
monitor heating of the deposited material using camera image data and the laser light beam, wherein control of the optical heating head includes using the camera image data to adjust focus and power of the laser light beam.

11. The device of claim 10, wherein the optical heating head is configured to output a focused laser light beam, and wherein control of the laser light beam includes control of laser light beam focus, laser light beam size, and laser light beam speed of movement.

12. The device of claim 10, wherein debinding includes control of the laser light beam to heat each layer of deposited material before depositing an additional layer.

13. The device of claim 10, wherein monitoring heating of the deposited material using camera image data includes inspecting deposited material for defects.

14. The device of claim 10, wherein emission of an inert gas is controlled to prevent metal powder particles from at least one of reacting and oxidizing in air in a printing chamber.

15. The device of claim 10, further comprising at least one of diluting, redirecting and filtering air in a printing chamber to remove fumes when optically heating deposited filament.

16. The device of claim 10, further comprising milling deposited material prior to heating deposited material.

17. The device of claim 10, further comprising a second tool head configured to deposit a material, wherein the controller is configured to control a tool head change to the second tool head, and control extruding of at least one layer of melted filament from the second tool head relative to at least one of the print bed and deposited material, wherein the first tool head and the second tool head are configured to print different materials to form at least a portion of an integrated part.

18. The device of claim 10, further comprising adjusting at least one of focus, size and power of a laser light beam of the optical head.

19. A method for multimaterial 3D printing, the method comprising:
setting, by a device, a first tool head;
extruding, by the device, at least one layer of melted filament from the first tool head relative to at least one of a print bed and a layer to deposit material;
controlling, by the device, a tool head change to a second tool head;
extruding, by the device, at least one layer of melted filament from the second tool head relative to at least one of the print bed and deposited material;
controlling, by the device, a tool head change to a third tool head;
milling, by the device, at least a portion of the deposited material;
controlling, by the device, a tool head change to a fourth tool head;
controlling, by the device, at least one optical heating head to generate a laser light beam to heat deposited material, wherein the optical heating head is controlled to heat deposited material to debind the deposited material and wherein the optical heating head is controlled to sinter debinded material.

20. The method of claim 19, further comprising monitoring heating of the deposited material using camera image data and the laser light beam, wherein control of the optical heating head includes using the camera image data to adjust focus and power of the laser light beam.
